(19) United States
(12) Patent Application Publication
(10) Pub. No.: US 2010/0245557 A1
(43) Pub. Date: Sep. 30, 2010

(54) INJECTION OF SECONDARY IMAGES INTO MICROSCOPE VIEWING FIELDS

(76) Inventors: Charles Luley, III, Milford, OH (US); Michael Charles Luley, Columbus, OH (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/750,315

(22) Filed: Mar. 30, 2010

Related U.S. Application Data
(60) Provisional application No. 61/165,252, filed on Mar. 31, 2009.

(51) Int. Cl. H04N 7/18; G02B 21/00

(52) U.S. Cl. 348/79; 359/368; 348/E07.091

(57) ABSTRACT

Systems and methods for injecting secondary images into viewing fields of surgical microscopes are disclosed. Some exemplary embodiments may provide secondary image injection in a picture-in-picture arrangement, thereby allowing a surgeon to simultaneously view the one or more secondary images and the surgical field through the oculars of the surgical microscope. Some exemplary embodiments may allow injection of secondary images including live video, such as live images from an endoscope, as well as previously obtained images, such as stored images from pre-operative studies.

### CROSS REFERENCE TO RELATED APPLICATION

This application claims the benefit of U.S. Provisional Application No. 61/165,252, filed Mar. 31, 2009, which is incorporated by reference.

### BACKGROUND

The present disclosure pertains to surgical microscopes and methods of using surgical microscopes and, more particularly to methods and systems for injecting secondary images into the viewing field of surgical microscopes.

The present disclosure contemplates that the following U.S. patents describe surgical microscopes, and their disclosures are incorporated herein by reference: U.S. Pat. Nos. 6,081,371; 6,088,154; 6,266,182; and 7,050,225.

### SUMMARY

Some exemplary embodiments may include systems and methods for injecting secondary images into viewing fields of surgical microscopes. Some exemplary embodiments may provide secondary image injection in a picture-in-picture arrangement, thereby allowing a surgeon to simultaneously view the one or more secondary images and the surgical field through the oculars of the surgical microscope. Some exemplary embodiments may allow injection of secondary images including live video, such as live images from an endoscope, as well as previously obtained images, such as stored images from pre-operative studies.

In an aspect, a method of operating a surgical microscope may include configuring a surgical microscope so that a surgical field image is visible through an ocular of the surgical microscope via an optical image path of the surgical microscope; and overlaying an overlaid image received as an electronic image signal on the surgical field image visible through the ocular of the surgical microscope via the optical image path such that the surgical field image and the overlaid image are simultaneously visible through the ocular of the surgical microscope.

In a detailed embodiment, the overlaid image may include a background and a first injected image, and the overlaying operation may include overlaying the overlaid image such that the background is substantially transparent and the first injected image substantially obscures a first portion of the surgical field image such that the first injected image appears as a picture-in-picture with respect to the surgical field image. In a detailed embodiment, the first injected image may overlay less than all of the surgical field image. In a detailed embodiment, the first injected image may overlay substantially all of the surgical field image. In a detailed embodiment, the overlaid image may include a second injected image, and the overlaying operation may include overlaying the overlaid image such that the second injected image substantially obscures a second portion of the surgical field image such that the second injected image appears as a picture-in-picture with respect to the surgical field image.

In a detailed embodiment, a method may include selecting the first injected image from a plurality of available image sources. In a detailed embodiment, the plurality of image sources may include at least one of a computed tomography image, a magnetic resonance image, an angiographic image, an endoscopic image, an image associated with monitoring equipment, an image associated with a consult, and a surgical atlas image. In a detailed embodiment, the first injected image may include an endoscopic image received from an endoscope, and a method may include coupling the endoscope to an endoscope light source including at least one light emitting diode.

In a detailed embodiment, a method may include displaying the overlaid image and a digitized version of the surgical field image on an external monitor in a picture-in-picture arrangement, the picture-in-picture arrangement being substantially identical to the surgical field image and overlaid image visible through the surgical microscope ocular.

In an aspect, a method of operating a surgical microscope may include forming an overlay image signal, the overlay image signal including a first injected image and a background image in a picture-in-picture arrangement; and delivering the overlay image signal to an image injection unit of a surgical microscope, the image injection unit being operative to display the overlay image signal on a surgical field image visible via an optical image path of the surgical microscope.

In a detailed embodiment, when viewed through the surgical microscope, the background image may be substantially transparent and the first injected image may at least partially obscure a portion of the surgical field image visible via the optical image path. In a detailed embodiment, a method may include receiving an injected image position selection corresponding to one of a plurality of available injected image positions, and forming the overlay image signal may include positioning the first injected image relative to the background image at a position corresponding to the injected image position selection. In a detailed embodiment, a method may include receiving an injected image size selection corresponding to one of a plurality of available injected image sizes, and forming the overlay image signal may include positioning the first injected image relative to the background image, the injected image having a size corresponding to the injected image size selection. In a detailed embodiment, forming the overlay image signal may include forming the overlay image signal including a second injected image. In a detailed embodiment, the first injected image may include live video received from an endoscope, and the live video received from the endoscope may be displayed in a picture-in-picture arrangement on the surgical field image visible through the optical path when viewed through the surgical microscope.

In an aspect, a surgical microscope image injection system may include means for selecting a first injected image from a plurality of image signals associated with a surgical procedure; means for forming an overlay image signal, the overlay image signal including the first one injected image and a background image; and means for displaying the overlay image signal in a pair of oculars of a surgical microscope so that the first injected image is displayed in a picture-in-picture arrangement with respect to an optical path image.

In a detailed embodiment, a surgical microscope image injection system may include means for selecting a second injected image from the plurality of image signals associated with the surgical procedure; the means for forming the overlay image signal may be operative to form the overlay image signal including the second injected image; and the means for displaying the overlay image signal in the pair of oculars of the surgical microscope may be operative to display both the first injected image and the second injected image in a picture-in-picture arrangement with respect to the optical path image. In a detailed embodiment, a surgical microscope image injection system may include means for forming an external display signal, the external display signal including the first injected image positioned in a picture-in-picture arrangement within an image substantially corresponding to the optical path image. In a detailed embodiment, a surgical microscope image injection system may include means for receiving input relating to at least one of which of the plurality of image signals associated with the surgical procedure should be the first injected image, a size of the first injected image in the overlay image signal, and a position of the first injected image in the overlay image signal. In a detailed embodiment, the first injected image may include an endoscopic image received from an endoscope, and the endoscope may be coupled to an endoscope light source including at least one light emitting diode and means for adjusting an intensity of light produced by the light emitting diode.

### BRIEF DESCRIPTION OF THE DRAWINGS

The detailed description refers to the following figures in which:

FIG. 1 is a schematic diagram of an exemplary image injection system;

FIG. 2 is a schematic illustration of an exemplary image injection system showing image signal interconnections;

FIG. 3 is a schematic illustration of an exemplary image injection system showing control interconnections;

FIG. 4 is a screen shot of an exemplary user interface for an image injection system;

FIG. 5 is a screen shot of an exemplary remote interface for an image injection system;

FIG. 6 is a perspective view of an exemplary light source for an endoscope;

FIG. 7 is a flowchart illustrating an example method of operating a surgical microscope; and

FIG. 8 is a flowchart illustrating an example method of operating a surgical microscope.

### DETAILED DESCRIPTION

The present disclosure includes, inter alia, image injection systems utilized in connection with surgical microscopes and methods of using surgical microscopes including image injection systems. Some example embodiments may overlay one or more injected images in a picture-in-picture (PIP) format in a stereoscopic microscope image. Thus, some example embodiments may allow a surgeon to maintain a stereoscopic view of an operative site through the oculars of a surgical microscope while simultaneously viewing one or more injected images in both oculars. In some exemplary embodiments, the one or more PIP images may appear to be overlaid such that they appear to be “on top” of the stereoscopic view of the operative site.

The present disclosure contemplates that surgeons, during surgical procedures utilizing surgical microscopes, may constantly or occasionally desire updated information from external sources such as, but not limited to, CT (computed tomography) images, MR (magnetic resonance) images, angiographic images, endoscopic images, monitoring equipment, Surgical Navigation System images, indocyanine green (ICG) fluorescence images, real-time consult input and/or surgical atlases to assist in the performance of the surgical procedures. The present disclosure contemplates that currently a surgeon typically shifts his or her eyes away from the optics of the surgical microscope and/or the surgical field to view these adjunct images and/or information. In some cases, surgeons may physically disengage themselves from the operative area to view these images on another display medium, such as a display located in another area of the operating theater. Thus, viewing adjunct images may disrupt the mental continuity and/or efficiency of the surgical procedure. In addition, leaving and re-entering the surgical field may increase the patient's risk of infection.

Some exemplary image injection systems according to the present disclosure may provide the ability to inject still and/or moving digital image(s) and/or information (such as text, graphics, charts, plots, and the like) into an operating microscope surgical viewing field, for example as picture-in-picture overlays. As used herein, “image” includes still and/or moving images, text, graphics, charts, plots, and the like. Thus, some exemplary image injection systems according to the present disclosure may reduce disruptions in surgical procedures by allowing surgeons to view supplemental information (in the form of one or more injected images) without moving their eyes away from the surgical microscope's viewing optics. In addition, some exemplary systems may also provide one or more image signals to one or more other recording and/or display media intra-operatively and/or post-operatively, such as for training and education purposes.

As used herein, overlaying refers to superimposing two or more still or moving images with respect to one another. In some exemplary embodiments, an image may be overlaid over substantially the entire optical surgical viewing field. Thus, at least a portion of the viewing field visible to a user may include both an optical path image and a overlaid image. Depending on the relative brightness of each image, one or both of the optical path image and the overlaid image may be more visible than the other. For example, if the brightness of the optical path image is reduced using the brightness controls on the microscope, it may appear as though only the overlaid image is visible to the user. Similarly, if the brightness of the overlaid image is reduced it may appear as though only the optical path image is visible to the user. Accordingly, brightness (or other image controls on one or both of the microscope and the image injection system) may be utilized to vary characteristics of the images visible to the surgeon through the oculars. In some exemplary embodiments, control of the system may be provided via a touch panel, which may be mounted to the microscope. Some exemplary embodiments may include controls for operation by hand, foot pedal and/or voice activation, and the like.

In some exemplary embodiments, an overlaid image may include one or more injected images and/or one or more background images. As used herein, injected image may generally refer to an image which may be visible through the oculars of an optical microscope in addition to or in place of the optical path image. In some exemplary embodiments according to the present disclosure, the surgeon may control many aspects of an injected image, such as it being visible or not, the position of the image in the surgical viewing field, and/or the size of the image. Further, in some exemplary embodiments, an operator may choose one or more images for injection from a plurality of available images and/or image sources. In some exemplary embodiments, a surgeon may control the relative brightness of an injected image by adjusting the brightness of the injected and/or overlaid image and/or by adjusting the brightness of the optical path image.

In some exemplary embodiments, the background image may substantially invisible (e.g., at least substantially transparent), thereby allowing the surgeon to view the optical path image “through” the background image. One or more injected images may be positioned within and/or adjacent to the background image. In some exemplary embodiments, the injected images may substantially obscure portions of the optical path image, thereby appearing “on top” of the optical path image.

Some exemplary image injection systems may utilize the multi-channel capabilities of one or more video processors to combine an injected image (such as an image from an endoscope) and a background image (which may be substantially black, for example) to provide an overlay image signal to a microscope image injection unit. In other words, an exemplary overlay image signal provided to a microscope image injector may be configured as a picture-in-picture, where one or more injected images may be provided within and/or adjacent to a larger background image.

Some exemplary microscope image injection systems according to the present disclosure may be configured to utilize image signals in a variety of formats, such as, but not limited to, SD-SDI (standard definition serial digital interface), HD-SDI (high definition serial digital interface), Composite Video (CV), YC (S-Video, also referred to as Separate Video), YUV Component, YPbPr HD Component DVI (digital video interactive), VGA (video graphics array), and/or RGB (red green blue).

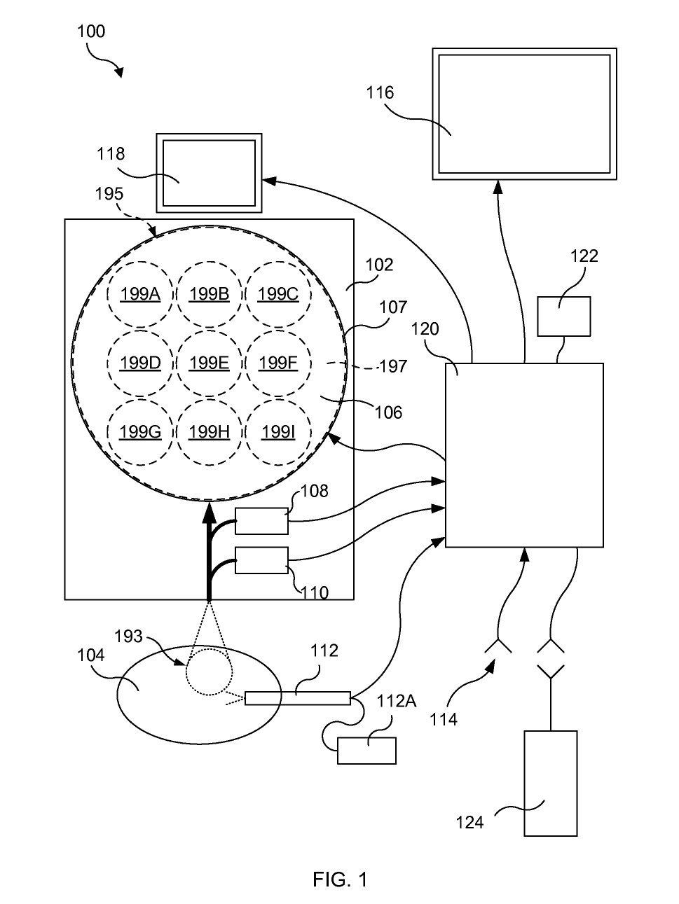

FIG. 1 is a schematic illustration of an exemplary image injection system 100 according to the present disclosure, which may include an image injection control unit 120. A surgical microscope 102, which may be configured for viewing a surgical field 104, may include viewing field 106 visible through one or more oculars 107. For example, a main surgeon's optics may include two oculars 107 configured for stereoscopic viewing of surgical field 104. One or more cameras, such as white light camera 108 and/or infrared camera 110, may be directed at the surgical field 104 and/or at other areas. Some exemplary cameras 108, 110 may include a high definition (HD) cameras (e.g., 1080p and/or 1080i) and/or HD-SDI outputs. Some exemplary cameras 108, 110 may be arranged to produce images substantially corresponding to the image of the surgical field visible through the optical path of the surgical microscope 102.

In some exemplary embodiments, infrared camera 110 may be used to view ICG fluorescence. ICG is a dye which may be administered intravenously for determining cardiac output, hepatic function, and liver blood flow, and for ophthalmic angiography, as well as detecting vascular abnormalities. The present disclosure contemplates that, in some circumstances, it may be advantageous to simultaneously view an ICG fluorescence image (e.g., as a PIP) and a stereoscopic optical path image of surgical field 104.

One or more endoscopes 112 may be placed in or near the surgical field 104 and/or in other areas. Endoscope 112 may be connected to a light source 112A. One or more connections 114 (which may include a VGA panel connector) may be configured to receive image data from other image sources, such as a hospital and/or radiology department network and/or system. For example, images in a DICOM (Digital Imaging and Communications in Medicine) format obtained during imaging studies of a patient may be received through connection 114. As another example, surgical navigation images may be received via connection 114. As another example, images obtained substantially in real-time during surgical procedures (e.g., fluoroscopy using C-arm devices) may be provided via connection 114. In general, image injection control unit may be configured to receive image signals from any device capable of providing image signals.

In some exemplary embodiments, viewing field 106 of microscope 102 may include an optical path image 193 and/or one or more overlaid images 195, which may include one or more background images 197 and/or one or more injected images 199A, 199B, 199C, 199D, 199E, 199F, 199G, 199H, 199I, such as images received from endoscope 112 and/or via connection 114. In some exemplary embodiments, one or more injected images 199A, 199B, 199C, 199D, 199E, 199F, 199G, 199H, 199I may have any shape, as one or more quadrants, semicircles, rectangles, etc. Image injection control unit 120 may be used to select, adjust, and/or control images which may be injected into viewing field 106 and/or displayed on room monitor 116 and/or external display 118 (e.g., a 1920×1080 display). Image control unit 120 may include one or more user interfaces, such as a touch screen interface 122 and/or a remote interface (RTP) 124.

One or more displays (e.g., flat panel monitors) may be configured to display various images. For example, one or more room monitors 116 (which may be local or remote) and/or one or more external displays 118 associated with microscope 102 may be provided. In some exemplary embodiments, external display 118 may include a touch panel monitor. In some exemplary embodiments, room monitors 116 and/or external displays 118 may display an overlaid image 195 and a digitized version of the surgical field image (e.g., from camera 108) in a picture-in-picture arrangement which may be substantially identical to the surgical field image (e.g., optical path image 193) and overlaid image 195 visible through surgical microscope ocular 107.

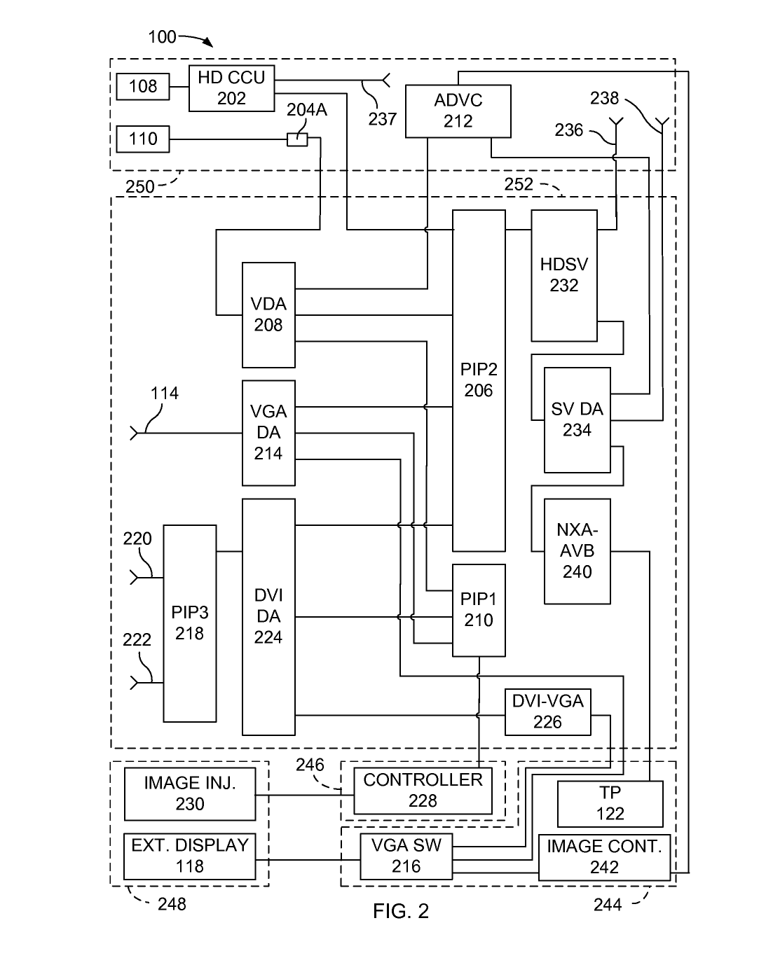

FIG. 2 is a schematic illustration of an exemplary image injection system 100 showing image signal interconnections. White light camera 108 may connect to HD CCU 202. HD CCU 202 may be connected to a video switcher/scaler (PIP2) 206 (for example, via a HD-SDI interface) and/or a connector 237, which may include a BNC panel connector. In some exemplary embodiments, connector 237 may be utilized for connecting to telemedicine systems. PIP2 206 may provide capabilities such as converting between various video formats and/or creating PIP windows. Some exemplary embodiments may include a physical disconnection (e.g., one or more plugs) along some cable paths, such as physical disconnection 204A. Infrared camera 110 may connect to distribution amplifier (VDA) 208 which may be connected to a video switcher/scaler (PIP1) 210, PIP2 206, and/or an advanced digital video convertor (ADVC) 212 (for example, via CV interfaces). ADVC 212 may convert SV signals into USB (universal serial bus) signals, for example. PIP1 210 may provide capabilities such as converting between various video formats and/or creating PIP windows. Connection 114 may be coupled to a distribution amplifier (VGA DA) 214, which may be connected to PIP1 210, PIP2 206, and/or a VGA switcher (VGA SW) 216 (for example, via VGA interfaces). VGA SW 216 may allow switching a single output to receive a signal from a plurality of inputs. One or more endoscopes 112 may be connected to a video switcher/scaler (PIP3) 218 via DVI (digital video interactive) panel connectors 220, 222 (for example, via DVI interfaces). PIP3 218 may provide capabilities such as converting between various video formats and/or creating PIP windows. PIP3 218 may be connected to a distribution amplifier (DVI DA) 224, which may be connected to PIP1 210, PIP2 206, and/or a DVI-VGA converter 226 (for example via DVI interfaces). PIP1 210 may be connected to a controller 228 (for example, via a DVI interface), which may be connected to an image injector 230 associated with microscope 102, which may provide, for example, a 1280×1024 binocular display. PIP2 206 may be connected to an HD SDI to SV converter (HDSV) 232 (for example, via an HD-SDI interface), which may be connected to a distribution amplifier (SV DA) 234 (for example, via an SV interface) and/or a connector 236 (such as a BNC panel connector for room monitor 116) (for example via an HD-SDI interface). SV DA 234 may be connected to ADVC 212, a connector 238 (such as an SV panel connector for room monitor 116), and/or an Ethernet video interface (NXA-AVB) 240 (for example, via SV interfaces), which may be connected to touch panel 122 (for example, via an Ethernet interface). AVDC 212 may be connected to an image control unit 242 (for example, via a USB interface), which may be connected to VGA SW 216 (for example, via a VGA interface).

In some exemplary embodiments, microscope 102 may comprise a model 20-1000 microscope available from Möller-Wedel. In some exemplary embodiments, image control unit 242, VGA SW 216, and/or touch panel 122 may be provided on a floor stand rail 244. An example of a commercially available image control unit 242 is the Microscope Imaging and Operation System (MIOS) available from Möller-Wedel, which may a computer and/or a touch panel configured to record video and/or control some microscope systems. HD CCU 202, infrared camera 110, and/or ADVC 212 may also be provided as part of the Möller-Wedel MIOS, and may be mounted in a housing 250. In some exemplary embodiments, controller 228 may be provided on a microscope base 246. In an exemplary embodiment, image injector 230 may be provided as part of a microscope head 248 and/or external display 118 may be mounted to microscope head 248. An example of a commercially available external display is the Microscope External Display (MEDIS) available from Möller-Wedel and which may mounted above the microscope's oculars. In some exemplary embodiments, various components may be provided within a housing 252, including appropriate power supplies.

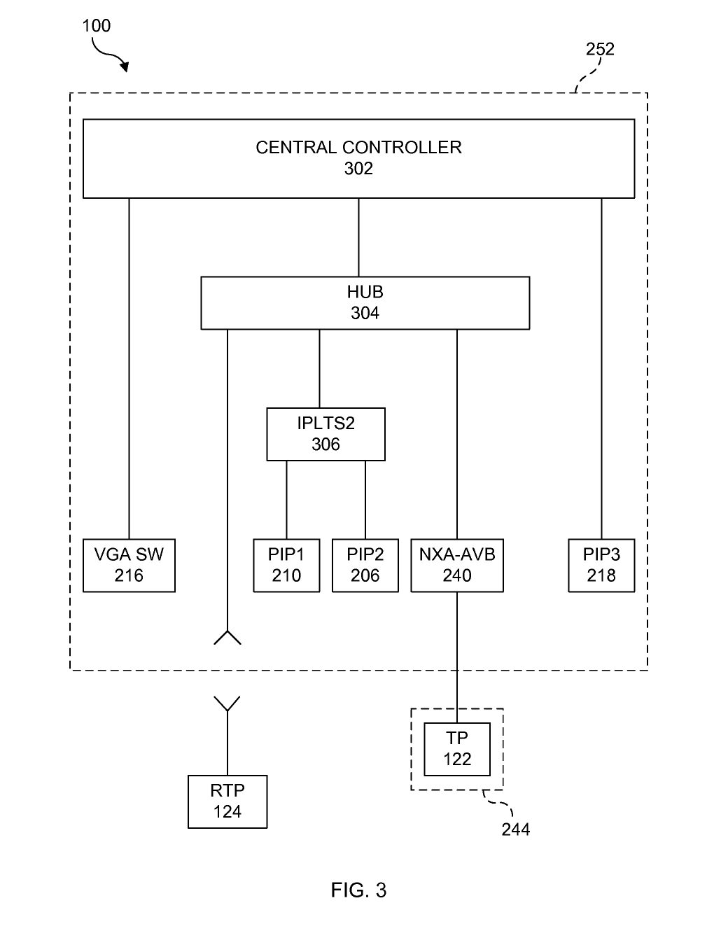

FIG. 3 is a schematic illustration of an exemplary image injection system 100 showing control interconnections. A central controller 302 may be connected to VGA SW 216 (for example, via an RS-232 interface), PIP3 218 (for example, via an RS-232 interface), and/or a hub 304 (e.g., a 5-port, 10/100 hub or switch) (for example, via a CAT-5 interface). Hub 304 may be connected to an Ethernet control interface (IPLTS2) 306, NXA-AVB 240, and/or an external connection 308 (e.g., an RJ45 panel connector) to which RTP 124 may be optionally connected (for example, via CAT-5 interfaces). IPLTS2 306 may be connected to PIP1 210 and/or PIP2 206 (for example, via RS-232 interfaces).

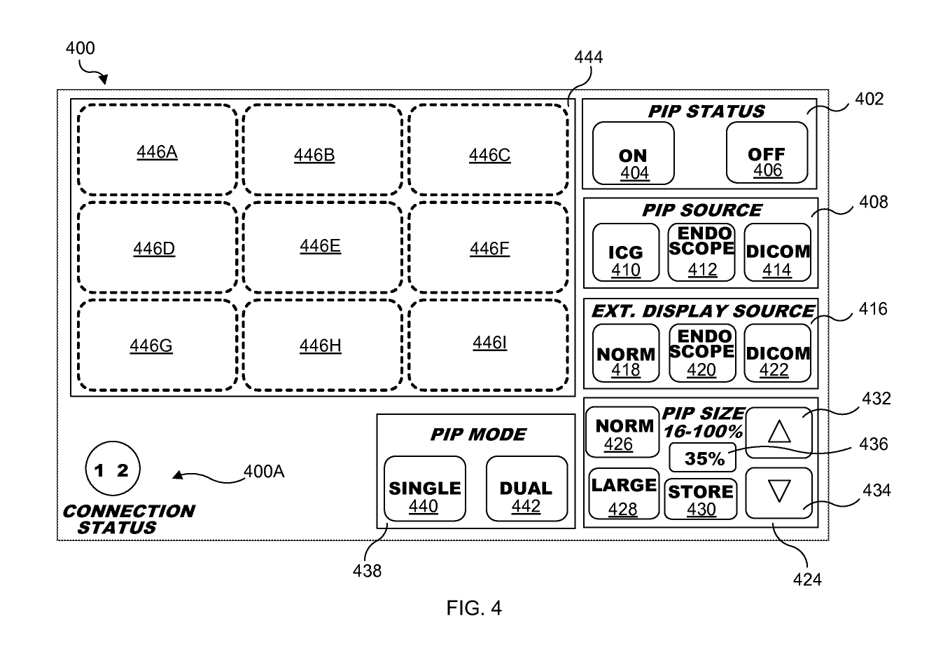

FIG. 4 is a screen shot of an exemplary user interface 400 for image injection system 100. In some exemplary embodiments, user interface 400 may be provided using touch screen interface 122, which may include portions of the screen which appear to be buttons and which may receive inputs based upon contact with those portions of the screen. Thus, as used herein, “button” refers to touch screen interface buttons as well as physical buttons.

In some exemplary embodiments, user interface 400 may include a PIP (picture-in-picture) status section 402, which may include an on button 404 and/or an off button 406. Selecting on button 404 may set PIP2 206 to picture-in-picture mode, may set the PIP size to normal, and may send live video (e.g., from HD CCU 202) with a picture-in-picture overlay to touch panel 122, connector 236, connector 238, and/or image control unit 242. Selecting off button 406 may set PIP2 206 to pass live video (e.g., from HD CCU 202) without picture-in-picture to touch panel 122, connector 236, connector 238, and/or image control unit 242.

User interface 400 may include a PIP source section 408, which may include an ICG button 410, an endoscope button 412, and/or a DICOM button 414. Selecting ICG button 410 may set PIP1 210 to receive a PIP image signal from infrared camera 110 and/or may set PIP2 206 to receive a PIP image signal from infrared camera 110. Thus, PIP1 210 and/or PIP2 206 may output a PIP image including an ICG fluorescence image. Selecting endoscope button 412 may set PIP1 210 and/or PIP2 206 to receive a PIP image signal from an endoscope via one or more of DVI panel connectors 220, 222. In some exemplary embodiments, the endoscope setting may be the default setting. Selecting DICOM button 414 may set PIP1 210 and/or PIP2 206 to receive a PIP image signal via connection 114.

User interface 400 may include an external display source section 416, which may include a normal button 418, and endoscope button 420, and/or a DICOM button 422. Selecting normal button 418 may set VGA SW 216 to receive a signal from image control unit 242. In some exemplary embodiments, this may be the default setting. Selecting endoscope button 420 may set VGA SW 216 to receive a full endoscope image from one or more of DVI panel connectors 220, 222 (e.g., via PIP3, DVI DA 224, and/or DVI-VGA 226). Selecting DICOM may set VGA SW 216 to receive an image from connection 114 (e.g., via VGA DA 214).

User interface 400 may include a PIP size section 424, which may include a normal button 426, a large button 428, a store button 430, an up arrow button 432, a down arrow button 434, and/or a size indicator 436. Selecting normal button 426 may set PIP1 210 and/or PIP2 206 PIP windows to predetermined normal sizes. Selecting large button 428 may set PIP1 210 and/or PIP2 206 PIP windows to predetermined large sizes. Selecting up arrow button 432 or down arrow button 434 may resize PIP windows in predetermined increments. Selecting and holding store button 430 may allow storing the current PIP window size as the predetermined normal size and/or the predetermined large size by subsequently selecting normal button 426 and/or large button 428.

User interface 400 may include a PIP mode section 438, which may include a single button 440 and/or a dual button 442. Selecting single button 440 may set PIP3 218 to receive an input from panel connector 220 (and may scale such input at 100%) and/or may set PIP2 206 V CROP (vertical crop) at 0%, for example. Selecting dual button 442 may configure PIP1 210 and/or PIP2 206 to display two PIPs, which may be side-by-side and/or scaled smaller, such as by 50%. In addition, PIP2 206 V CROP may be set at 50%, for example. Some exemplary embodiments may include a swap button, which may toggle the arrangement of two PIPs (e.g., right PIP moves to the left and left PIP moves to the right).

User interface 400 may include a PIP location selection section 444, which may include PIP positions 446A, 446B, 446C, 446D, 446E, 446F, 446G, 446H, 4461. Selecting any one of PIP positions 446A, 446B, 446C, 446D, 446E, 446F, 446G, 446H, 4461 may set PIP1 210 and/or PIP2 206 to the selected position.

Some exemplary embodiments may include a connection status indicator 400A, which may indicate whether or not certain communication interfaces are operational. For example, the digits “1” and “2” may indicate whether Ethernet and/or RS-232 interfaces are operational by being displayed in colors such as green (communicating) and red (not communicating).

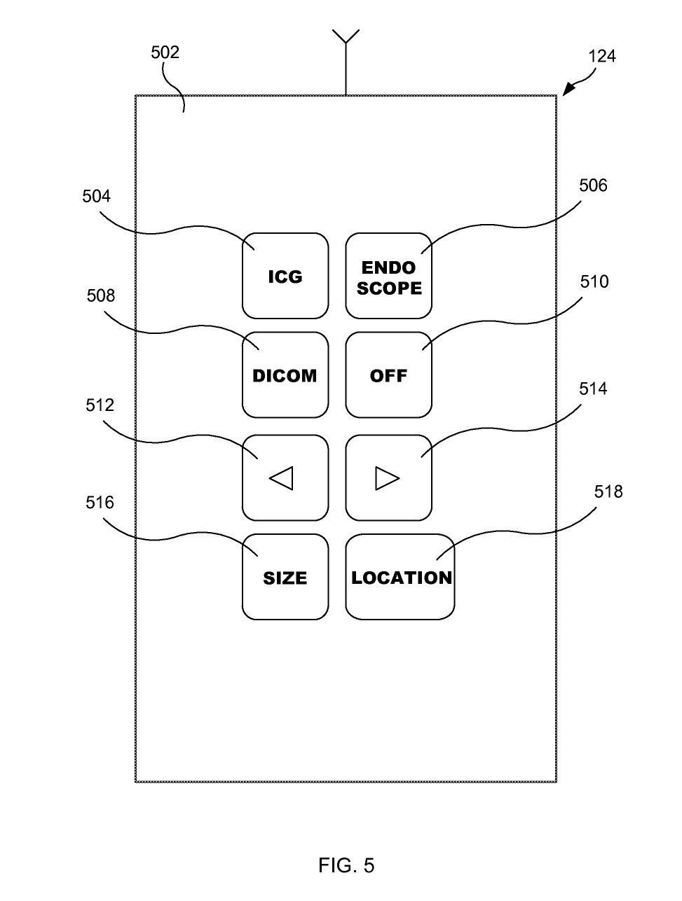

FIG. 5 is a screen shot of an exemplary remote interface 124 for an image injection system. Remote interface 124 may be wired and/or wireless and may be placed beneath a sterile cover to allow use by a surgical technician or surgeon. In some exemplary embodiments, Remote interface 124 may connect to housing 252 via a CAT-5 cable and/or an RJ45 panel mount jack.

Remote interface 124 may include a touch screen 502. Remote interface 124 may include an ICG button 504, an endoscope button 506, a DICOM button 508, an off button 510, a left arrow button 512, a right arrow button 514, a size button 516, and/or a location button 518. Selecting ICG button 504 may turn on PIP1 210 and/or PIP2 206 and/or may select infrared camera 110 as the input source. Selecting endoscope button 506 may turn on PIP1 210 and/or PIP2 206 and/or may select one or more of DVI connections 220, 222 as the input source. Selecting DICOM button 508 may turn on PIP1 210 and/or PIP2 206 and/or may select connection 114 as the input source. Selecting OFF button 510 may turn off PIP1 210 and/or PIP2 206. Selecting size button 516 may allow use of left arrow button 512 and/or right arrow button 514 to increase and/or decrease the image size. Selecting location button 518 may allow use of left arrow button 512 and/or right arrow button 514 to move the PIP image between PIP positions 446A, 446B, 446C.

Some exemplary embodiments may include user interfaces in place of and/or in addition to remote interface 124. For example, some exemplary embodiments may include one or more additional a touch screens, hand controls mounted on or near microscope 102, foot controls, and/or voice activation components.

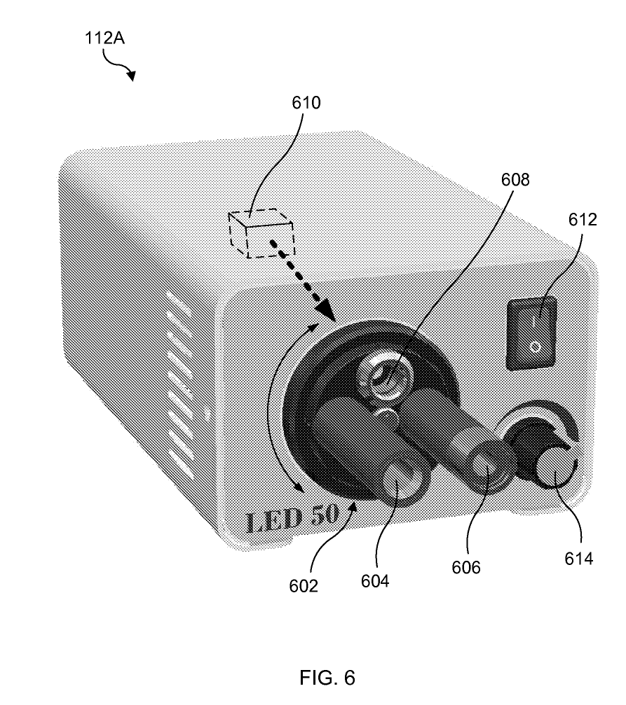

FIG. 6 is a perspective view of an exemplary light source 112A for an endoscope. In some exemplary embodiments, light source 112A may comprise a light emitting diode (LED). The present disclosure contemplates that conventional endoscope light sources may include halogen and/or xenon lamps, which may cause heating of tissue via the endoscope. Some exemplary light sources 112A according to the present disclosure may include one or more LEDs which may cause less tissue heating than comparable halogen and/or xenon lamps.

Some exemplary light sources 112A may include a turret 602, which may be rotatable to align one of a plurality of ports 604, 606, 608 with one or more LEDs 610. Ports 604, 606, 608 may be configured for connection to different brands and/or types of endoscopes. Light source 112A may include a power switch 612, an intensity adjustment knob 614. In some exemplary embodiments, LED 610 may produce light with a color temperature of about 6500° K. Some exemplary LEDs 610 may have an expected life of greater than about 50,000 hours and/or may have a low power consumption (e.g., about 52 W) as compared to halogen and/or xenon lamps. Some exemplary embodiments may utilize pulse width modulation to vary the intensity of light produced by LED 610, which may be adjustable using adjustment knob 614.

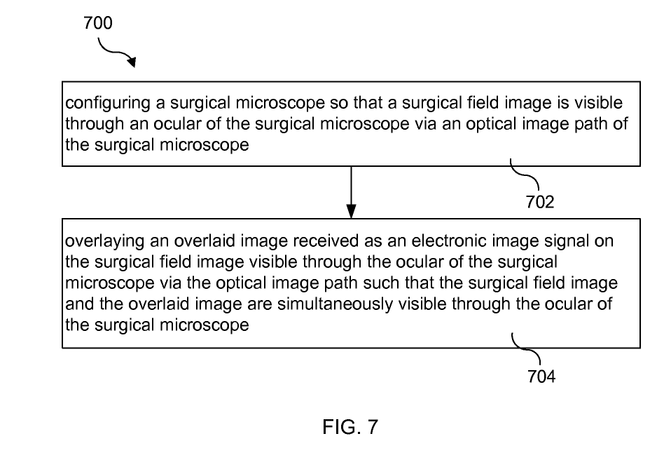

FIG. 7 is a flowchart illustrating an example method 700 of operating a surgical microscope. Operation 702 may include configuring a surgical microscope so that a surgical field image is visible through an ocular of the surgical microscope via an optical image path of the surgical microscope. Operation 704 may include overlaying an overlaid image received as an electronic image signal on the surgical field image visible through the ocular of the surgical microscope via the optical image path such that the surgical field image and the overlaid image are simultaneously visible through the ocular of the surgical microscope.

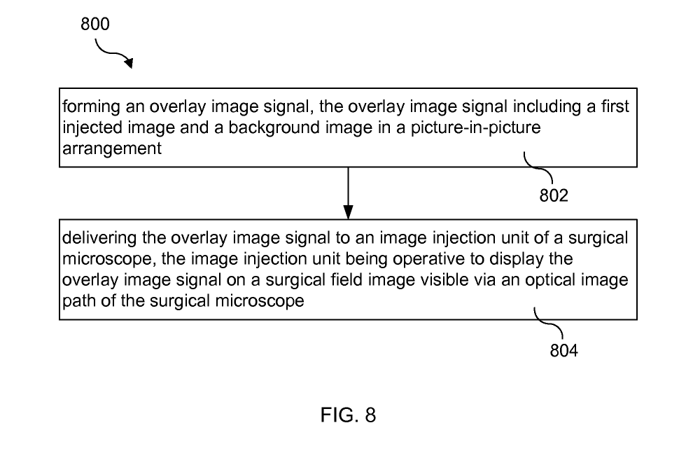

FIG. 8 is a flowchart illustrating an example method 800 of operating a surgical microscope. Operation 802 may include forming an overlay image signal, the overlay image signal including a first injected image and a background image in a picture-in-picture arrangement. Operation 804 may include delivering the overlay image signal to an image injection unit of a surgical microscope, the image injection unit being operative to display the overlay image signal on a surgical field image visible via an optical image path of the surgical microscope.

As used in this application, when it is described that one component is “coupled” to or with another component, or is “connected” to or with another component, such terminology does not necessarily require a physical or direct connection. For example, with respect to electronic components, two or more electronic components may be “coupled” to one another by an electronic coupling or data coupling, where such electronic or data couplings may be direct, wired or wireless couplings and may even include additional components “coupled” therebetween along the electronic or data path. Similarly, two or more optical components may be optically coupled to one another by an optical coupling, where such optical coupling may be direct or indirect and may include additional components “coupled” therebetween along the optical path. Further, it is within the scope of the disclosure to physically and/or functionally combine or separate various components described herein. For example, it is within the scope of the disclosure to provide functions performed by various separate components disclosed herein using one or more computers, which may include one or more central processing units. As another example, it is within the scope of the disclosure to provide a plurality of components described herein within an enclosure and/or to power such components from a power supply.

While exemplary embodiments have been set forth above for the purpose of disclosure, modifications of the disclosed embodiments as well as other embodiments thereof may occur to those skilled in the art. Accordingly, it is to be understood that the disclosure is not limited to the above precise embodiments and that changes may be made without departing from the scope. Likewise, it is to be understood that it is not necessary to meet any or all of the stated advantages or objects disclosed herein to fall within the scope of the disclosure, since inherent and/or unforeseen advantages of the may exist even though they may not have been explicitly discussed herein.

1. A method of operating a surgical microscope, the method comprising:
configuring a surgical microscope so that a surgical field image is visible through an ocular of the surgical microscope via an optical image path of the surgical microscope; and
overlaying an overlaid image received as an electronic image signal on the surgical field image visible through the ocular of the surgical microscope via the optical image path;
wherein the surgical field image and the overlaid image are simultaneously visible through the ocular of the surgical microscope.

2. The method of claim 1,
wherein the overlaid image includes a background and a first injected image; and
wherein the overlaying operation includes overlaying the overlaid image such that the background is substantially transparent and the first injected image substantially obscures a first portion of the surgical field image such that the first injected image appears as a picture-in-picture with respect to the surgical field image.

3. The method of claim 2, wherein the first injected image overlays less than all of the surgical field image.

4. The method of claim 2, wherein the first injected image overlays substantially all of the surgical field image.

5. The method of claim 2,
wherein the overlaid image includes a second injected image; and
wherein the overlaying operation includes overlaying the overlaid image such that the second injected image substantially obscures a second portion of the surgical field image such that the second injected image appears as a picture-in-picture with respect to the surgical field image.

6. The method of claim 2, further comprising, selecting the first injected image from a plurality of available image sources.

7. The method of claim 6, wherein the plurality of image sources includes at least one of a computed tomography image, a magnetic resonance image, an angiographic image, an endoscopic image, an image associated with monitoring equipment, a Surgical Navigation System image, an indocyanine green (ICG) fluorescence image, an image associated with a consult, and a surgical atlas image.

8. The method of claim 7, wherein the first injected image comprises an endoscopic image received from an endoscope; and the method further comprises coupling the endoscope to an endoscope light source including at least one light emitting diode.

9. The method of claim 2, further comprising displaying the overlaid image and a digitized version of the surgical field image on an external monitor in a picture-in-picture arrangement, the picture-in-picture arrangement being substantially identical to the surgical field image and overlaid image visible through the surgical microscope ocular.

10. A method of operating a surgical microscope, the method comprising:
forming an overlay image signal, the overlay image signal including a first injected image and a background image in a picture-in-picture arrangement; and
delivering the overlay image signal to an image injection unit of a surgical microscope, the image injection unit being operative to display the overlay image signal on a surgical field image visible via an optical image path of the surgical microscope.

11. The method of claim 10, wherein, when viewed through the surgical microscope, the background image is substantially transparent and the first injected image at least partially obscures a portion of the surgical field image visible via the optical image path.

12. The method of claim 10, further comprising receiving an injected image position selection corresponding to one of a plurality of available injected image positions;
wherein forming the overlay image signal includes positioning the first injected image relative to the background image at a position corresponding to the injected image position selection.

13. The method of claim 10, further comprising receiving an injected image size selection corresponding to one of a plurality of available injected image sizes;
wherein forming the overlay image signal includes positioning the first injected image relative to the background image, the injected image having a size corresponding to the injected image size selection.

14. The method of claim 10, wherein forming the overlay image signal includes forming the overlay image signal including a second injected image.

15. The method of claim 10,
wherein the first injected image includes live video received from an endoscope; and
wherein the live video received from the endoscope is displayed in a picture-in-picture arrangement on the surgical field image visible through the optical path when viewed through the surgical microscope.

16. A surgical microscope image injection system comprising:
means for selecting a first injected image from a plurality of image signals associated with a surgical procedure;
means for forming an overlay image signal, the overlay image signal including the first one injected image and a background image; and
means for displaying the overlay image signal in a pair of oculars of a surgical microscope so that the first injected image is displayed in a picture-in-picture arrangement with respect to an optical path image.

17. The surgical microscope image injection system of claim 16, further comprising means for selecting a second injected image from the plurality of image signals associated with the surgical procedure; wherein the means for forming the overlay image signal is operative to form the overlay image signal including the second injected image; and wherein the means for displaying the overlay image signal in the pair of oculars of the surgical microscope is operative to display both the first injected image and the second injected image in a picture-in-picture arrangement with respect to the optical path image.

18. The surgical microscope image injection system of claim 16, further comprising means for forming an external display signal, the external display signal including the first injected image positioned in a picture-in-picture arrangement within an image substantially corresponding to the optical path image.

19. The surgical microscope image injection system of claim 16, further comprising means for receiving input relating to at least one of which of the plurality of image signals associated with the surgical procedure should be the first injected image, a size of the first injected image in the overlay image signal, and a position of the first injected image in the overlay image signal.

20. The surgical microscope image injection system of claim 16, wherein the first injected image includes an endoscopic image received from an endoscope; and wherein the endoscope is coupled to an endoscope light source including at least one light emitting diode and means for adjusting an intensity of light produced by the light emitting diode.
